(19) United States
(12) Patent Application Publication
(10) Pub. No.: US 2026/0006689 A1
(43) Pub. Date: Jan. 1, 2026

(54) SINGLE CHIP LED DRIVER CIRCUIT

(71) Applicant: Microchip Technology Inc., Chandler, AZ (US)

(72) Inventors: Mircea Calin, Bucharest (RO); Dragos Ionut Danaila, Bucharest (RO); Marius Enachescu, Bucharest (RO); Alexandru Vidrasan, Bucharest (RO)

(73) Assignee: Microchip Technology Inc., Chandler, AZ (US)

(21) Appl. No.: 18/830,235

(22) Filed: Sep. 10, 2024

Related U.S. Application Data
(60) Provisional application No. 63/665,303, filed on Jun. 28, 2024.

(51) Int. Cl. H05B 45/10; H05B 45/34; H05B 45/37; H05B 47/16

(52) U.S. Cl. CPC H05B 45/10; H05B 45/34; H05B 45/37; H05B 47/16

(57) ABSTRACT

A light-emitting diode (LED) driver circuit for driving an LED and electrically connectable to an activation interface. The LED driver circuit may include a controller, a binary counter, a digital-to-analog converter (DAC), and a voltage controller current source (VCCS). The controller may receive an activation signal from the activation interface and generate a control signal. The binary counter may be electrically connected to the controller and receive the control signal from the controller and generate a code. The DAC may be electrically connected to the binary counter and receive the code from the binary counter and generate an analog signal. The VCCS may be electrically connected to the DAC, receive the analog signal from the DAC, and control a brightness of the LED based on the analog signal.

### CROSS-REFERENCE TO RELATED APPLICATIONS

The current patent application claims the benefit under 35 U.S.C. § 119 (e) of the priority date of U.S. Provisional Application Ser. No. 63/665,303; titled “SINGLE CHIP SOLUTION FOR LOW VOLTAGE AND LOW POWER LED DRIVER”; and filed Jun. 28, 2024. The Provisional Application is hereby incorporated by reference, in its entirety, into the current patent application.

### TECHNICAL FIELD

Various examples of the present disclosure relate to a single chip light emitting diode (LED) driver circuit having touch controls, dimming controls, and a timer.

### BACKGROUND

LED driver circuits often have bulky packaging and must be hard wired into an installation in order to be operated. Many LED driver circuits have a high component count, consume significant amounts of energy, and have significant costs. Large, expensive LED driver installations may not be desirable for certain applications, such as emergency devices, industrial indicators, disposable devices, and simple visual indicators.

This background discussion is intended to provide information related to the present invention which is not necessarily prior art.

### SUMMARY OF THE INVENTION

According to various examples of the present disclosure, a light emitting diode (LED) driver circuit for driving an LED may be provided. The LED driver circuit may be connectable to an activation interface. The LED driver circuit may include a controller, a binary counter, a digital-to-analog converter (DAC), and a voltage controlled current source (VCCS). The controller may be electrically connectable to the activation interface. The controller may be configured to receive an activation signal from the activation interface. The binary counter may be electrically connected to the controller. The binary counter may be configured to receive the control signal from the controller and generate a code. The DAC may be electrically connected to the binary counter. The DAC may be configured to receive the code from the binary counter and generate an analog signal. The VCCS may be electrically connected to the DAC. The VCCS may be configured to receive the analog signal from the DAC and control a brightness of the LED based on the analog signal.

According to various examples of the present disclosure, a system may be provided. The system may include an LED, an activation interface, and an integrated circuit (IC). The activation interface may be configured to generate an activation signal. The IC may include a controller, a binary counter, a digital-to-analog converter (DAC), and a voltage controlled current source (VCCS). The controller may be electrically connectable to the activation interface. The controller may be configured to receive an activation signal from the activation interface. The binary counter may be electrically connected to the controller. The binary counter may be configured to receive a control signal from the controller and generate a code. The DAC may be electrically connected to the binary counter. The DAC may be configured to receive the code from the binary counter and generate an analog signal. The VCCS may be electrically connected to the DAC. The VCCS may be configured to receive the analog signal form the DAC and control a brightness of the LED based on the analog signal.

According to various examples of the present disclosure, a method for operating an LED driver circuit may be provided. An activation interface may receive an activation input. The activation interface may generate an activation signal in response to receiving the activation input. A controller of the LED driver circuit may generate a control signal based on the activation input. A binary counter of the LED driver circuit may generate a code based on the control signal. ADAC of the LED driver circuit may receive the code. The DAC may generate an analog signal based on the code. A voltage controlled current source (VCCS) of the LED driver circuit may receive the analog signal. The VCCS and a charge pump of the LED driver circuit may drive an LED.

### BRIEF DESCRIPTION OF THE DRAWINGS

FIG. 1 illustrates an example integrated circuit (IC) package including an LED driver circuit;

FIG. 2 illustrates an example system including a circuit layout of the LED driver circuit of FIG. 1; and

FIG. 3 illustrates an example method of operating the LED driver chip of FIG. 1.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

In various examples of the present disclosure, an LED driver circuit may be provided. The LED driver circuit may be used in various applications, such as industrial indicators, visual indicators, disposable devices, and emergency lighting. The LED driver circuit may be a standalone device and may drive an integrated LED. The LED driver circuit may be powered by one or more batteries included in the LED driver circuit. The LED driver circuit may have an activation interface for activating the LED. The activation interface may include one or more of a touch button, touch sensor, and switch for enabling a user to activate and adjust a brightness of the LED. In various examples, the LED driver circuit may be a single integrated circuit (IC) chip.

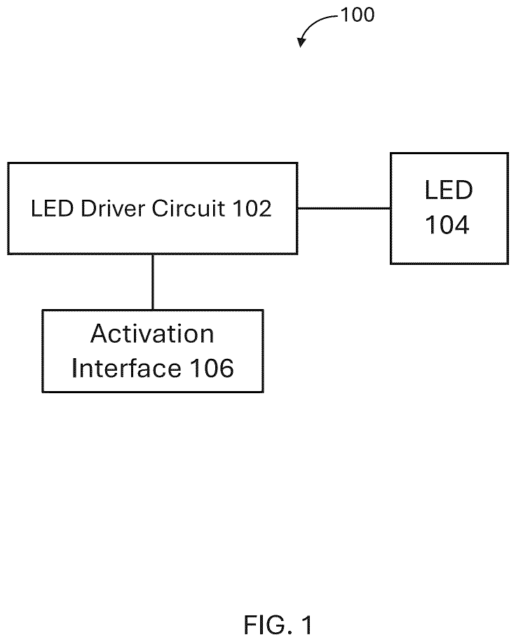

FIG. 1 illustrates an example integrated circuit (IC) package 100 including a light emitting diode (LED) driver circuit 102, an LED 104, and an activation interface 106. The LED driver circuit 102 may include or comprise a single IC chip. The LED driver circuit 102 may be electrically connected to the LED 104 and the activation interface 106. The LED driver circuit 102 may be operable to drive the LED 104.

In various examples, the activation interface 106 may receive an activation input. In response to receiving the activation input, the activation interface 106 may generate an activation signal for activating the LED driver circuit 102. In various examples, the activation interface 106 may include a user interface. The user interface may include one or more of a switch, touch sensor, push button, and a variable resistor, without limitation. A user may adjust a brightness of the LED 104 by providing input via the activation interface 106. In various examples, the activation interface 106 may include one or more sensors configured to activate the LED driver circuit 102 in response to detecting a trigger condition. The one or more sensors may include optical sensor(s), vibrational sensor(s), magnetic sensor(s), infrared sensor(s), microwave sensor(s), ultrasonic sensor(s), and motion sensor(s), without limitation.

In various examples, the activation signal may include a brightness value for controlling a brightness of the LED 104. The brightness value may be dynamically adjusted based on user input received via the activation interface 106. The activation interface 106 may generate a second activation signal including a second brightness value in response to receiving a second user input. The brightness of the LED 104 may be adjusted by the LED driver circuit 102 based on the second brightness value.

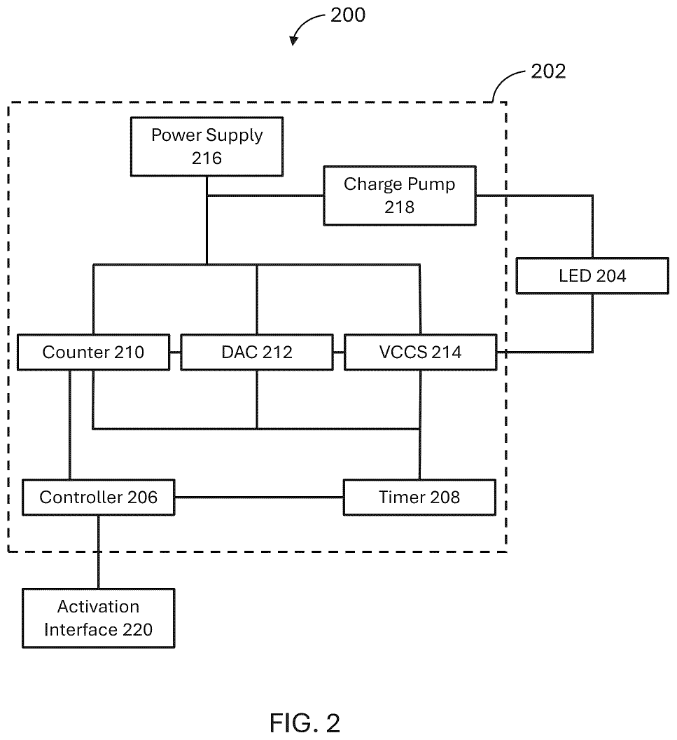

The LED Driver circuit 102 may include circuitry, as discussed with reference to FIG. 2, to activate and control the brightness of the LED 104. The LED driver circuit 102 may additionally include a timer to deactivate the LED 104 after a predetermined amount of time. In some examples, the activation interface 106 may include a user interface to enable a user to select the predetermined amount of time. In another example, the predetermined amount of time may be selected when the LED driver circuit 102 is manufactured and may be coded into the timer. In various examples, the timer may be reprogrammed to adjust the predetermined amount of time.

FIG. 2 illustrates a system 200 including an LED driver circuit 202, an LED 204, and an activation interface 220. The LED driver circuit 202 may include a controller 206, a timer 208, a binary counter 210, a digital-to-analog converter (DAC) 212, a voltage controlled current source (VCCS) 214, a power supply 216, and a charge pump 218. The controller 206 may be electrically connected to the activation interface 220, the timer 208, and the binary counter 210. The timer 208 may be electrically connected to the counter 210, the DAC 212, and the VCCS 214. The power supply 216 may be electrically connected to the binary counter 210, the DAC 212, the VCCS 214, and the charge pump 218. The LED 204 may be electrically connected to the VCCS 214 and the charge pump 218.

In various examples, the activation interface 220 may receive an activation input. In response to receiving the activation input, the activation interface 220 may generate an activation signal for activating the LED driver circuit 202. In various examples, the activation interface 220 may include a user interface. The user interface may include one or more of a switch, touch sensor, push button, and a variable resistor, without limitation. A user may adjust a brightness of the LED 204 by providing input via the activation interface 220. In various examples, the activation interface 220 includes one or more sensors configured to activate the LED driver circuit 102 in response to detecting a trigger condition. The one or more sensors may include optical sensor(s), vibrational sensor(s), magnetic sensor(s), infrared sensor(s), microwave sensor(s), ultrasonic sensor(s), and motion sensor(s), without limitation.

In various examples, the activation signal may include a brightness value for controlling a brightness of the LED 204. The brightness value may be dynamically adjusted based on user input received via the activation interface 220. The activation interface 220 may generate a second activation signal including a second brightness value in response to receiving a second user input. The brightness of the LED 204 may be adjusted by the LED driver circuit 102 based on the second brightness value.

The controller 206 may receive the activation signal from the activation interface 220. The controller 206 may generate a control signal in response to receiving the activation signal. The control signal may include the brightness value. The control signal may be provided to the binary counter 210 and the timer 208. In various examples, the timer 208 may generate a clock signal in response to receiving the control signal. The clock signal may enable activation of the binary counter 210, the DAC 212, and the VCCS 214. In various examples, the timer 208 may be configured to periodically provide the clock signal to the binary counter 210, the DAC 212, and the VCCS 214. The timer 208 may provide the clock signal for a predetermined period of time. The binary counter 210, the DAC 212, and the VCCS 214 may generate respective output signals each time the clock signal is received. After the predetermined period of time has ended, the timer 208 may stop providing the clock signals to deactivate the binary counter 210, the DAC 212, and the VCCS 214.

In various examples, the predetermined period of time may be selectable by the user. The activation interface 220 may include a timer interface for enabling the user to select the predetermined amount of time. The timer interface may include one or more of a switch, touch sensor, push button, and a variable resistor, without limitation. In other examples, the predetermined amount of time may be programmed within the timer 208 during manufacture of the LED driver circuit 202. In various examples, the timer 208 may be reset upon receiving a second activation signal. When the timer 208 is reset, the timer 208 may deactivate the binary counter 210, the DAC 212, and the VCCS 214 after the predetermined amount of time has elapsed, unless a further activation signal is received.

The binary counter 210 may generate a code in response to receiving the control signal. In various examples, the code may be a five (5) bit code. In other examples, the code may include more or less than five (5) bits. The code may include the brightness value. The code may be provided to the DAC 212. In various examples, the DAC 212 may be a five (5) bit DAC configured to receive the five (5) bit code. In other examples, the DAC 212 may be configured to receive a code having more or less than five (5) bits. The DAC 212 may generate an analog signal in response to receiving the code. A voltage level of the analog signal may correspond to the brightness value. Accordingly, the voltage level may be representative of the brightness value included in the code. The analog signal may be provided to the VCCS 214. The VCCS 214 may control the brightness of the LED 204 in response to receiving the analog signal and based on the voltage level.

The charge pump 218 and the VCCS 214 may drive the LED 204. The charge pump 218 may supply a source voltage to the LED 204. The VCCS 214 may receive a sink current from the LED 204. The VCCS 214 may control an amount of sink current that is received based on the voltage level of the analog signal. The amount of sink current received by the VCCS 214 may control the brightness of the LED 204. In various examples, the VCCS 214 may be a non-linear current source. Accordingly, the VCCS 214 may enable the brightness of the LED 204 to be constant and provide lower power dissipation and improved operating efficiency compared to a linear current source.

In various examples, the power supply 216 may supply power to the various circuitry components of the LED driver circuit 202. The power supply 216 may be electrically connected to and supply electrical power to the binary counter 210, the DAC 212, and the VCCS 214. In various examples, the power supply 216 may be electrically connected to and supply electric power to the controller 206 and the timer 208. In various examples, the power supply 216 may be a single cell battery. The single cell battery may reduce a size of the LED driver circuit 202 compared to other power supplies, such as power supplies for hard wired LED installations. In other examples, the power supply 216 may include one or more batteries, capacitor(s), and supercapacitor(s), without limitation.

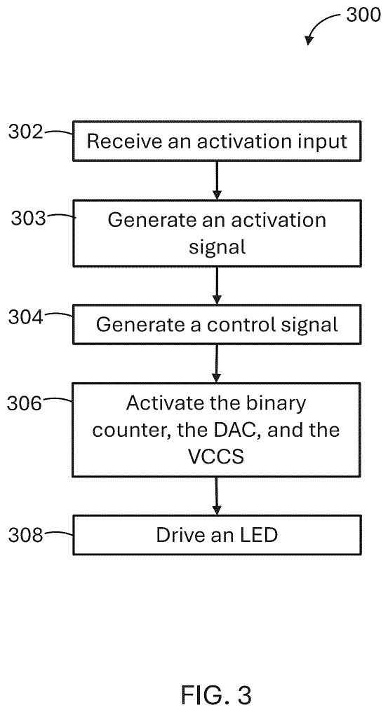

FIG. 3 illustrates an example method for operating an LED driver circuit, such as the LED driver circuit 102 of FIG. 1 or the LED driver circuit 202 of FIG. 2. The LED driver circuit may include a controller, a binary counter, a digital-to-analog converter (DAC), a voltage controller current source (VCCS), a power supply, a charge pump, and a timer. In various examples, the components of the LED driver circuit may correspond to the controller 206, timer 208, binary counter 210, DAC 212, VCCS 214, power supply 216, and charge pump 218 as described with reference to FIG. 2.

The binary counter and the timer may be electrically connected to the controller. The timer may be electrically connected to the binary counter, the DAC, and the VCCS. The DAC may be electrically connected to the counter. The VCCS may be electrically connected to the DAC. The power supply may be electrically connected to the charge pump, the binary counter, the DAC, and the VCCS. The charge pump and the VCCS may be electrically connected to an LED.

At operation 302, an activation input may be received. The activation input may correspond to a user input or a sensed input. The activation interface may include a user interface, such as a switch, touch sensor, push button, and a variable resistor, without limitation. The user input may be a user selection of the activation interface. The sensed input may correspond to a trigger condition sensed by one or more sensors. The one or more sensors may include optical sensor(s), vibrational sensor(s), magnetic sensor(s), infrared sensor(s), microwave sensor(s), ultrasonic sensor(s), and motion sensor(s), without limitation. The activation input may include a selection of a brightness value. The brightness value may be used to control a brightness of the LED. The brightness value may be dynamically adjusted based on user input received via the activation interface.

At operation 303, the activation interface may generate an activation signal in response to receiving the activation input. The activation signal may include the brightness value. The activation signal may be provided to the controller.

At operation 304, the controller may generate a control signal in response to receiving the activation signal. The control signal may include the brightness value. The control signal may be provided to the timer and the binary counter.

At operation 306, the binary counter, the DAC, and the VCCS may be activated. In various examples, the timer may generate a clock signal to activate the binary counter, the DAC, and the VCCS. In various examples, the timer may be configured to periodically provide the clock signal to the binary counter, the DAC, and the VCCS. The timer may provide the clock signal for a predetermined period of time. The binary counter, the DAC, and the VCCS to generate respective output signals each time the clock signal is received. After the predetermined period of time has ended, the timer may stop providing the clock signals to deactivate the binary counter, the DAC, and the VCCS.

In various examples, the power supply may supply power to the various circuitry components of the LED driver circuit. The power supply may be electrically connected to and supply electrical power to the binary counter, the DAC, and the VCCS. In various examples, the power supply may be electrically connected to and supply electric power to the controller and the timer. In various examples, the power supply may be a single cell battery. The single cell battery may reduce a size of the LED driver circuit compared to other power supplies, such as power supplies for hard wired LED installations. In other examples, the power supply may include one or more batteries, capacitor(s), and supercapacitor(s), without limitation.

In various examples, the predetermined period of time may be selectable by the user. The activation interface may include a timer interface for enabling the user to select the predetermined amount of time. The timer interface may include one or more of a switch, touch sensor, push button, and a variable resistor, without limitation. In other examples, the predetermined amount of time may be programmed within the timer during manufacture of the LED driver circuit. In various examples, the timer may be reset upon receiving a second activation signal. When the timer is reset, the timer may deactivate the binary counter, the DAC, and the VCCS after the predetermined amount of time has elapsed, unless a further activation signal is received.

At operation 308, the LED may be driven by the charge pump and the VCCS. The binary counter may generate a code in response to receiving the control signal. The code may include the brightness value. In various examples, the code may be a five (5) bit code. In other examples, the code may include more or less than five (5) bits. The code may be provided to the DAC. In various examples, the DAC may be a five (5) bit DAC configured to receive the five (5) bit code. In other examples, the DAC may be configured to receive a code having more or less than five (5) bits. The DAC may generate an analog signal in response to receiving the code. A voltage level of the analog signal may correspond to the brightness value. Accordingly, the voltage level may be representative of the brightness value included in the code. The analog signal may be provided to the VCCS. The VCCS may control the brightness of the LED in response to receiving the analog signal and based on the voltage level.

The charge pump may supply a source voltage to the LED. The VCCS may receive a sink current from the LED. The VCCS may control an amount of sink current that is received based on the voltage level of the analog signal. The amount of sink current received by the VCCS may control the brightness of the LED. In various examples, the VCCS may be a non-linear current source. Accordingly, the VCCS may enable the brightness of the LED to be constant and provide lower power dissipation and improved operating efficiency compared to a linear current source.

According to various examples of the present disclosure, a light emitting diode (LED) driver circuit for driving an LED may be provided. The LED driver circuit may be connectable to an activation interface. The LED driver circuit may include a controller, a binary counter, a digital-to-analog converter (DAC), and a voltage controlled current source (VCCS). The controller may be electrically connectable to the activation interface. The controller may be configured to receive an activation signal from the activation interface. The binary counter may be electrically connected to the controller. The binary counter may be configured to receive the control signal from the controller and generate a code. The DAC may be electrically connected to the binary counter. The DAC may be configured to receive the code from the binary counter and generate an analog signal. The VCCS may be electrically connected to the DAC. The VCCS may be configured to receive the analog signal form the DAC and control a brightness of the LED based on the analog signal.

In combination with any of the previous examples, the LED driver circuit may include a timer electrically connected to the binary counter, the DAC, and the VCCS. The timer may be configured to deactivate the binary counter, the DAC, and the VCCS after a predetermined amount of time.

In combination with any of the previous examples, the LED driver circuit may include a power supply and a charge pump. The power supply may be electrically connected to the VCCS, the binary counter, and the DAC. The charge pump may be electrically connected to the power supply and configured to supply a source voltage to the LED.

In combination with any of the previous examples, the VCCS may be configured to receive a sink current from the LED. The VCCS may be a non-linear current source.

In combination with any of the previous examples, the control signal may include a brightness value. The binary counter may generate the code to include the brightness value. The DAC may generate the analog signal to have a voltage value representative of the brightness value.

In combination with any of the previous examples, the LED driver circuit may be a single integrated circuit (IC) chip.

According to various examples of the present disclosure, a system may be provided. The system may include an LED, an activation interface, and an integrated circuit (IC). The activation interface may be configured to generate an activation signal. The IC may include a controller, a binary counter, a digital-to-analog converter (DAC), and a voltage controlled current source (VCCS). The controller may be electrically connectable to the activation interface. The controller may be configured to receive an activation signal from the activation interface. The binary counter may be electrically connected to the controller. The binary counter may be configured to receive the control signal from the controller and generate a code. The DAC may be electrically connected to the binary counter. The DAC may be configured to receive the code from the binary counter and generate an analog signal. The VCCS may be electrically connected to the DAC. The VCCS may be configured to receive the analog signal form the DAC and control a brightness of the LED based on the analog signal.

In combination with any of the previous examples, the IC may include a timer electrically connected to the binary counter, the DAC, and the VCCS. The timer may be configured to deactivate the binary counter, the DAC, and the VCCS after a predetermined amount of time.

In combination with any of the previous examples, the IC may include a power supply and a charge pump. The power supply may be electrically connected to the VCCS, the binary counter, and the DAC. The charge pump may be electrically connected to the power supply and configured to supply a source voltage to the LED.

In combination with any of the previous examples, the VCCS may be configured to receive a sink current from the LED. The VCCS may be a non-linear current source.

In combination with any of the previous examples, the control signal may include a brightness value. The binary counter may generate the code to include the brightness value. The DAC may generate the analog signal to have a voltage value representative of the brightness value.

In combination with any of the previous examples, the activation interface may be configured to receive a user input including a selection of the brightness value and generate the activation signal including the brightness value.

In combination with any of the previous examples, the activation interface may include at least one of a push button, a sensor, and a switch.

According to various examples of the present disclosure, a method for operating an LED driver circuit may be provided. An activation interface may receive an activation input. A controller of the LED driver circuit may generate a control signal based on the activation input. A binary counter of the LED driver circuit may generate a code based on the control signal. A DAC of the LED driver circuit may receive the code. The DAC may generate an analog signal based on the code. A voltage controlled current source (VCCS) of the LED driver circuit may receive the analog signal. The VCCS and a charge pump of the LED driver circuit may drive an LED.

In combination with any of the previous examples, driving, by the charge pump, the LED may include supplying, by the charge pump, a source voltage to the LED.

In combination with any of the previous examples, driving, by the VCCS, the LED may include receiving, by the VCCS, a sink current from the LED. The VCCS may be a non-linear current source.

In combination with any of the previous examples, the control signal may include a brightness value. The code may include the brightness value. The analog signal may have a voltage value representative of the brightness value. A brightness of the LED may be controlled by the VCCS based on the analog signal.

In combination with any of the previous examples, the activation interact may be a user interface. The user interface may receive a user input including a selection of the brightness value. The user interface may generate the activation signal to include the brightness value.

In combination with any of the previous examples, a timer of the LED driver circuit may deactivate the VCCS, the DAC, and the binary counter after a predetermined amount of time.

In combination with any of the previous examples, the LED driver circuit may be a single integrated circuit (IC) chip.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A light-emitting diode (LED) driver circuit for driving an LED and electrically connectable to an activation interface, said LED driver circuit comprising:
a controller electrically connectable to the activation interface, said controller configured to receive an activation signal from the activation interface and generate a control signal;
a binary counter electrically connected to the controller, said binary counter configured to receive the control signal from the controller and generate a code;
a digital-to-analog converter (DAC) electrically connected to the binary counter, said DAC configured to receive the code from the binary counter and generate an analog signal; and
a voltage controlled current source (VCCS) electrically connected to the DAC, said VCCS configured to receive the analog signal from the DAC and control a brightness of the LED based on the analog signal.

2. The LED driver circuit of claim 1, comprising
a timer electrically connected to the binary counter, the DAC, and the VCCS,
said timer configured to deactivate the binary counter, the DAC, and the VCCS after a predetermined amount of time.

3. The LED driver circuit of claim 1, comprising
a power supply electrically connected to the VCCS, the binary counter, and the DAC,
a charge pump electrically connected to the power supply, said charge pump configured to supply a source voltage to the LED.

4. The LED driver circuit of claim 1, said VCCS configured to receive a sink current from the LED, wherein the VCCS is a non-linear current source.

5. The LED driver circuit of claim 1,
wherein said control signal includes a brightness value,
said binary counter generating the code to include the brightness value,
said DAC generating the analog signal to have a voltage value representative of the brightness value.

6. The LED driver circuit of claim 1,
wherein the LED driver circuit is a single integrated circuit (IC) chip.

7. A system comprising:
a light emitting diode (LED);
an activation interface configured to generate an activation signal; and
an integrated circuit (IC) comprising—
a controller electrically connected to the activation interface, said controller configured to receive the activation signal from the activation interface and generate a control signal,
a binary counter electrically connected to the controller, said binary counter configured to receive the control signal from the controller and generate a code,
a digital-to-analog converter (DAC) electrically connected to the binary counter, said DAC configured to receive the code from the binary counter and generate an analog signal, and
a voltage controlled current source (VCCS) electrically connected to the DAC, said VCCS configured to receive the analog signal from the DAC and control a brightness of the LED.

8. The system of claim 7,
said IC including a timer electrically connected to the binary counter, the DAC, and the VCCS,
said timer configured to deactivate the binary counter, the DAC, and the VCCS after a predetermined amount of time.

9. The system of claim 7, wherein the IC includes—
a power supply electrically connected to the VCCS, the binary counter, and the DAC,
a charge pump electrically connected to the power supply, said charge pump configured to drive the LED.

10. The system of claim 7, said VCCS configured to receive a sink current from the LED, wherein the VCCS is a non-linear current source.

11. The system of claim 7,
said control signal including a brightness value,
said binary counter generating the code to include the brightness value,
said DAC generating the analog signal to have a voltage value representative of the brightness value.

12. The system of claim 11, wherein the activation interface is a user interface,
said activation interface configured to receive a user input including a selection of the brightness value and generate the activation signal including the brightness value.

13. The system of claim 12, wherein the activation interface includes at least one of a push button, a touch sensor, and a switch.

14. A method for operating a light emitting diode (LED) driver circuit, comprising:
receiving, by an activation interface, an activation input;
generating, by the activation interface, an activation signal;
generating, by a controller of the LED driver circuit, based on the activation signal, a control signal;
generating, by a binary counter of the LED driver circuit, based on the control signal, a code;
receiving, by a digital-to-analog converter (DAC) of the LED driver circuit, the code;
generating, by the DAC, based on the code, an analog signal;
receiving, by a voltage controlled current source (VCCS) of the LED driver circuit, the analog signal; and
driving, by the VCCS and a charge pump of the LED driver circuit, based on the analog signal, an LED.

15. The method for operating the LED driver circuit of claim 14,
wherein driving, by the charge pump, the LED includes supplying, by the charge pump, a source voltage to the LED.

16. The method for operating the LED driver circuit of claim 14,
wherein driving, by the VCCS, the LED includes receiving, by the VCCS, a sink current from the LED, wherein the VCCS is a non-linear current source.

17. The method for operating the LED driver circuit of claim 14,
wherein said control signal includes a brightness value, said code includes the brightness value, and said analog signal has a voltage value representative of the brightness value,
wherein a brightness of the LED is controlled by the VCCS based on the analog signal.

18. The method of operating the LED driver circuit of claim 17,
wherein the activation interface is a user interface,
said user interface receiving a user input including a selection of the brightness value,
said user interface generate the activation signal to include the brightness value.

19. The method for operating the LED driver circuit of claim 14, comprising
deactivating, by a timer of the LED driver circuit, the VCCS, the DAC, and the binary counter after a predetermined amount of time.

20. The method for operating the LED driver circuit of claim 14,
wherein the LED driver circuit is a single integrated circuit (IC) chip.
